(19) United States
(12) Patent Application Publication
(10) Pub. No.: US 2006/0136969 A1
(43) Pub. Date: Jun. 22, 2006

(54) Ordering promotional materials during motion picture showing

(76) Inventors: David L. Patton, Webster, NY (US); John R. Fredlund, Rochester, NY (US); Kenneth A. Parulski, Rochester, NY (US); Stephen H. Shaw, Rochester, NY (US)

Correspondence Address: Pamela R. Crocker;Patent Legal Staff, Eastman Kodak Company, 343 State Street, Rochester, NY, 14650-2201, US

(21) Appl. No.: 11/022,163

(22) Filed: Dec. 22, 2004

(51) Int. Cl. H04N 7/18; H04N 5/445; G06F 13/00; G06F 3/00

(52) U.S. Cl. 725/78; 725/61; 725/60

(57) ABSTRACT

A method provides, at an exhibition site, a promotional item. A motion picture is displayed at the exhibition site. At least one audience member is provided an order entry device for recording an order for the promotional item during the motion picture showing. The order is obtained from the order entry device.

### FIELD OF THE INVENTION

This invention generally relates to digital cinema and more particularly relates to a method and apparatus for ordering supplemental promotional items either before, during, or after a presentation of a motion picture.

### BACKGROUND OF THE INVENTION

With the advent of digital cinema, considerable attention has been directed to potential commercial advantages that become available when using content that is generated and transmitted electronically. For example, digital cinema enables to provide multiple versions of a movie or of movie scenes, as well as the capability to adapt the content of individual scenes to audience demographics. Because the content of the motion picture and its associated advertising is transmitted electronically, there is additional flexibility for control of content, thereby allowing opportunities for adapting displayed content to local conditions and audience preferences. Other technical advantages will allow more flexible display arrangements as well as opportunity for color enhancement and other imaging improvements. In addition to these technical and performance advantages, there also appears to be considerable advantages and opportunities for more economical motion picture distribution, for improved adaptation to markets and viewer demographics, for local customization of some types of content, and for an overall development of a more engrossing theater experience. Along with these advantages come enhanced opportunities for revenue enhancement both for studios that produce and distribute motion picture content and for theaters that show this content to audiences.

The conventional model for motion picture film distribution is characterized by rigid control of the entire distribution and display process, allowing minimal or no flexibility for local adaptation. Referring to FIG. 1, there is shown a block diagram of a prior art conventional motion picture film distribution system 10. A production studio 20 takes the content from content providers 22 who generate the film feature, advertising, trailers, previews, and other content for theater display, typically as separate content films 30. Studio 20 edits, masters, and prepares print films 24 and provides them, through a distribution network 26 to theaters 28. In the conventional model of FIG. 1, studio 20 dictates what is viewed at each theater 28. This control of what gets shown extends not only to the film feature itself, but also to any advertising or trailers, such as previews for future offerings, and the like. In the conventional arrangement, theaters 28 follow the instructions of studio 20 for display of the film feature and other related content. With the relatively inflexible arrangement shown in FIG. 1, there is no opportunity for dynamically adding or changing image content.

Theater revenues are primarily from admission fees and concession sales, often with some additional revenue from local and national advertisers for material displayed between showings. Theaters, however, have little participation in additional profits from movie-related items. Items that promote the motion picture and its stars include such items as posters, T-shirts, and other accessories. These promotional items are sold by stores and other outlets not related to the theater. Thus, while studios and motion picture distributors enjoy a share of the profits from sales of supplemental promotional items to movie fans, the theater does not derive any direct benefit from these sales.

It is well known that many consumers are more likely to purchase various types of items on impulse, based on experiencing an event such as a motion picture. Theater owners, however, are largely unable to take advantage of the type of consumer enthusiasm that often follows the viewing of a popular motion picture. Among practical obstacles are the cost of inventory, complexities of ordering and inventory management, required floor and storage space, and theft and security considerations. Thus, while it can be appreciated that the capability for offering promotional items to the movie audience would have advantages for movie theater owners, workable schemes for taking advantage of this opportunity have not been developed.

Items promoting a movie, such as posters and banners, are currently provided to the theater owner in printed form. These items can be expensive to ship and may not arrive in sufficient time for advertising an upcoming feature to current customers. Many motion picture fans would have an interest in purchasing movie posters, as provided to the theater or in personalized form. However, using conventional distribution practices, theater owners are not able to print their own posters for display, nor can they take advantage of potential revenues from the sale of these items.

Other revenue possibilities could be obtained from sales of items that include desirable portions of the motion picture content, including soundtrack audio. For example, many moviegoers would be favorably disposed to purchase the movie soundtrack following the showing. Using conventional distribution methods, however, it may be too costly or cumbersome for theater management to stock, manage, and sell quantities of conventionally produced CDs, DVDs, or other recorded materials for current films.

Impulse buying behavior is believed to influence retail sales of items related to entertainment events and personalities. However, conventional techniques fall somewhat short of taking advantage of audience enthusiasm during an entertainment event. It can be appreciated, for example, that methods for obtaining customer orders or requests for promotional items during the entertainment event itself could be particularly beneficial to the theater operator. By providing the opportunity to order items when enthusiasm is at its peak, the theater operator, or other provider of entertainment events, could increase sales of such items, particularly where the item ordered can be provided to the consumer upon exiting the theater or auditorium.

Thus, it can be seen that there is a need for solutions that allow a theater owner to encourage impulse buying and to provide cinema-related promotional items to audiences in a timely and flexible fashion, without incurring high inventory expenses.

### SUMMARY OF THE INVENTION

The aforementioned needs are met with the present invention by a method for providing, at an exhibition site, a promotional item, the method comprising the steps of:

(a) displaying a motion picture at the exhibition site;

(b) providing, to at least one audience member, an order entry device for recording an order for the promotional item during the motion picture showing;

and, (c) obtaining the order placed using the order entry device.

A second aspect of the present invention provides a method for providing a promotional item at an entertainment event, the method comprising the steps of:

(a) providing, to at least one audience member, a wireless order entry device for ordering the promotional item during the event;

(b) displaying a prompt to the at least one audience member for recording an order for the promotional item using the order entry device during the event;

(c) obtaining, from wireless transmission, the order recorded using the order entry device.

A third aspect of the present invention provides a method for providing a promotional item at an entertainment event, the method comprising the steps of:

(a) providing, to at least one audience member, an entry device for ordering the promotional item during the event;

(b) displaying a prompt to the at least one audience member for recording an order for the promotional item using the order entry device during the event;

(c) obtaining, from wired transmission, the order placed using the order entry device.

A fourth aspect of the present invention provides a method for providing a promotional item at an entertainment event, the method comprising the steps of:

(a) providing, to at least one audience member, a manual entry device for recording an order for the promotional item during the event;

(b) displaying a prompt to the at least one audience member for ordering the promotional item using the order entry device during the event; and, (c) obtaining a completed manual entry device from the at least one audience member.

A fifth aspect of the present invention provides a method for providing a promotional item at an entertainment event, the method comprising the steps of:

(a) providing, to at least one audience member, a ticket to the entertainment event;

(b) scanning the ticket; and, (c) displaying a selection menu for selection of promotional items corresponding to the entertainment event.

A feature of the present invention is the inclusion of promotional data content within the image data stream itself.

It is an advantage of the present invention that it allows flexibility for preparation of suitable promotional materials at the motion picture theater itself, both for current and upcoming features.

It is a further advantage of the present invention that it allows the theater owner to offer customers a range of promotional items related to a film showing, yet without the need to stock and manage substantial amounts of inventory.

It is yet a further advantage of the present invention that it allows the theater owner to provide promotional items related to a motion picture that can be customized for the individual consumer.

These and other features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic block diagram showing a conventional prior art system for motion picture film preparation and distribution.

FIG. 2 is a schematic block diagram showing an exemplary system for mastering and providing digital motion picture data for implementing the present invention.

FIG. 3 is a block diagram showing an arrangement of output devices provided for generation of promotional items at a movie theater.

FIG. 4 is a block diagram showing major data components of an image data stream that provides the image data including both recordable and non-recordable segments.

FIG. 5 is a perspective view of an entertainment site, showing an arrangement for displaying prompts and receiving order entry data.

FIG. 6 is a block diagram of a kiosk for selection, payment, and customization, according to the present invention.

FIG. 7 is a plan view showing typical interface screens provided on an order entry device.

FIG. 8 is a perspective view showing an order entry device in one embodiment.

FIGS. 9 and 10 are operator interface screens displayed at a kiosk or other order entry terminal.

FIG. 11 is a plan view showing a ticket or coupon used as an order entry mechanism.

FIG. 12 is a block diagram showing a fulfillment apparatus.

FIG. 13 is an example prompt displayed on an auxiliary screen or on part of the main projection screen during a showing; and, FIG. 14 is a logic flow diagram showing the basic steps for carrying out the method of the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The term “motion picture” as used in this specification is applied broadly to include not only a conventional film-based motion picture or an electronically stored “digital cinema” motion picture, but also a broadcast event that is taking place, or has already occurred, at some remote site. This broad definition can include audio and video content of a broadcast concert, performance, sporting event, or other event, for example, where the broadcast event is displayed at a motion picture theater or other suitable exhibition site.

The method of the present invention can be used with digital motion picture showings as well as with conventional, film-based entertainment events. The present invention can also be used with electronically broadcast events, including concerts, performances, and sporting events, for example.

Thus, what is provided is a method and apparatus for ordering supplemental promotional items during a motion picture showing, including items obtained from the data stream for a digital motion picture or other electronic entertainment.

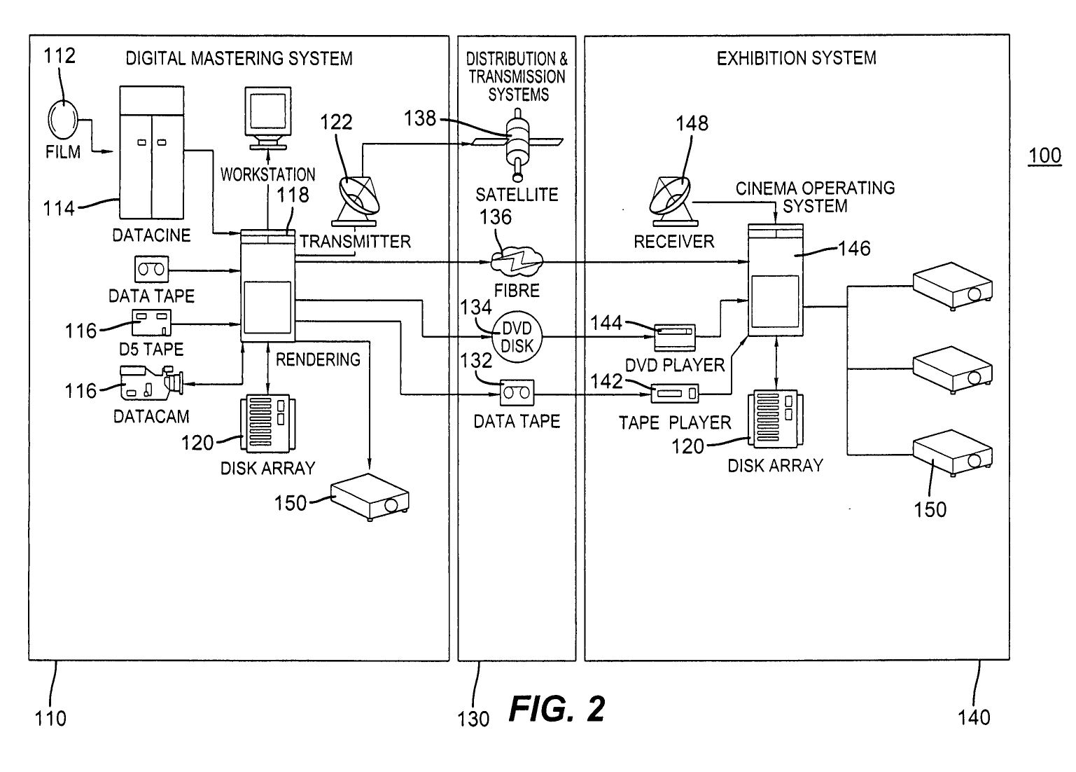

One of the potential benefits of digital cinema relates to how images and audio are stored and displayed from data. Referring to FIG. 2, there is shown a block diagram of a digital cinema preparation and distribution system 100, according to the present invention, for providing motion picture images from a studio 110, over a transmission system 130 to an exhibition system 140, typically a movie theater. The movie theater includes an exhibition site. The exhibition site includes the lobby, the display screens and projection devices, gaming areas, dining facilities and refreshment stands, and exit/entrance areas and anticipated extended areas proximate to the theater. These areas are well known to those skilled in the art and those that view movies at these exhibition sites. At studio 110, digital mastering is performed on film 112 that contains image content, such as the film feature, advertising, trailers, and the like. A datacine system 114 transforms the film content into digital image content and provides the digital image content to a rendering system 118, typically supported by a disk array 120, that renders the motion picture image data in a resolution suitable for distribution and display. Rendering system 118 may also accept input from auxiliary input devices 116 such as data tape, DS tape, and DataCam devices. The fully mastered digital cinema output then is provided as a data stream to transmission system 130, which may utilize a satellite 138 in communication with a transmitter 122 connected to studio 110 equipment. Other alternative transmission media include a fiber cable connection 136, or transmission using an optical medium 134, such as DVD or optical disks, or using a magnetic medium 132, such as data tape, or using some other type of medium. At exhibition system 140, the mastered digital image data is received, such as at a receiver 148, an optical media reader 144, a magnetic media reader 142 or over a data or fiber optic cable connection 136. A cinema operating system 146, typically supported by disk array 120 or some other mass data storage apparatus using electronic, optical, magnetic, or other types of storage media, accepts the digital input data, processes the input data stream for presentation, and provides this data for image forming and projection by one or more electronic projectors 150.

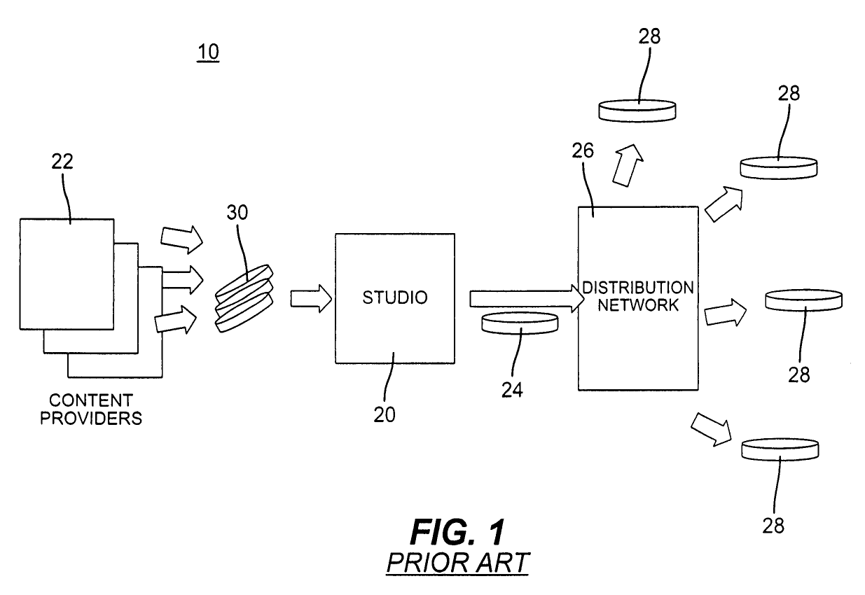

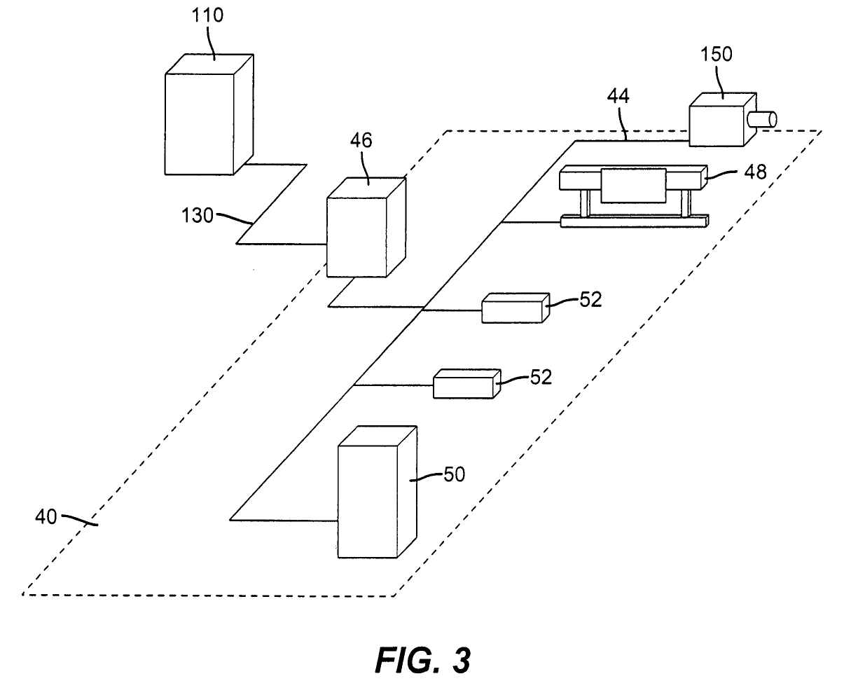

Referring to FIG. 3, there is shown an entertainment system 40 according to the present invention and that is shown in exhibition system 140 of FIG. 2. A control logic processor 46, which may be a separate computer or microcomputer or may be identical with cinema operating system 146 (shown in FIG. 2), accesses transmitted data that has been provided over transmission system 130 and that is typically stored by means of some mass data storage apparatus, as described hereinabove with reference to FIG. 1. Control logic processor 46 connects along a network 44 to electronic projector 150 and to one or more output devices. The output devices are for recording a supplemental portion of the transmitted data onto an item of some type for forming a promotional item. Output devices may include one or more recording apparatus 52, a large-format printer 48, or other devices, including output devices associated with a kiosk 50. The promotional item can be recorded onto any of a number of types of media, including, but not limited to, optical and magnetic media, textiles, paper, ceramics, and plastics, for example.

Large-format printer 48 may be an inkjet, thermal, laser, or other type of printer suited for printing posters and banners, for example. With this capability, a theater owner can print promotional posters on-site. This would allow the theater owner to print and use an appropriate number of posters or banners for a site, depending on available wall space, audience interest, and timing, for example. The theater owner also has the opportunity to print and sell posters to consumers. Even though it may take several minutes to prepare a large-scale print, posters can be printed at the presentation site during idle time, such as during a showing, so that prints are ready for sale at the end of the event. Posters may be standard posters prepared under the control of studio 110 or, optionally, may be customized, such as using kiosk 50 capabilities, described subsequently.

Recording apparatus 52 may be any of a number of different types of devices for providing images, for recording audio data, or for copying software, or for recording image data, for example. A color printer, such as a thermal printer or photographic printer, could be employed to provide 8×10 prints or printed material in other useful formats. Recording apparatus 52 may also be a printer for writing coupons, tickets, or other appropriate materials. Recording apparatus 52 could be a device for recording onto optical media, such as CDs and DVDs for example. This capability would enable the theater owner to provide audio and/or video clips related to the motion picture from the motion picture itself, or to other upcoming attractions. For example, desirable scenes, snippets or soundtrack music from a film could be available as a promotional item, recorded onto CD or DVD at the site or delivered/transmitted wirelessly as photo messages or text messages that incorporate scene content or supplemental promotional data, such as product web sites for products that are used in the movie. One or more trailers or out-takes from existing or upcoming motion pictures could be provided, for printing onto DVD. Video trailers or selected out-takes could be provided for free or at a nominal price, based on promotional needs of a theater or distributor. A trailer, out-take, still images, or other sample segment of a motion picture could be rendered at lower resolution, to enable faster printing of DVDs. Similarly, audio clips could be provided at low cost for promoting music associated with the motion picture. The content included can be selected by the user when a user selection function is enabled.

Recording apparatus 52 could also be a device that records encoding data onto a storage medium that enables or disables one or more portions of stored content. With this arrangement, for example, multiple DVDs having scenes from a motion picture could be mass-produced and shipped to the theater. The theater operator can then sell each DVD separately, customizing the contents by enabling specific scenes based on consumer characteristics or on payment terms. For example, a DVD could be prepared with all of the content of a motion picture, organized in modular fashion into individual scenes. Each scene could then be sold separately, or groupings of scenes bundled together for a single price. Alternately, different rated versions (PG, PG-13, R, for example) of the movie could be provided by configuring the DVD to play the appropriate scenes for each specific version. Using this arrangement, recording apparatus 52 can be used to quickly configure individual DVDs for departing audience members, based on their payment and on other criteria. Alternate types of optical, magnetic, or electronic storage devices could also be provided as promotional items, such as portable memory devices that plug into a computer port or other electronic item. Devices having portions of data that can be selectively enabled or disabled could be used.

In another embodiment, recording apparatus 52 is a printer equipped for writing onto T-shirts and other types of wearing apparel. Using an apparatus such as a thermal printer or a thermal transfer from an electro-photographic system would enable the consumer to obtain a wearable memento of the motion picture immediately before or after a showing, at the motion picture presentation site itself. Other types of recording apparatus 52 could be employed for writing tattoo materials, coffee mugs, and other types of promotional items.

Data Transmittal

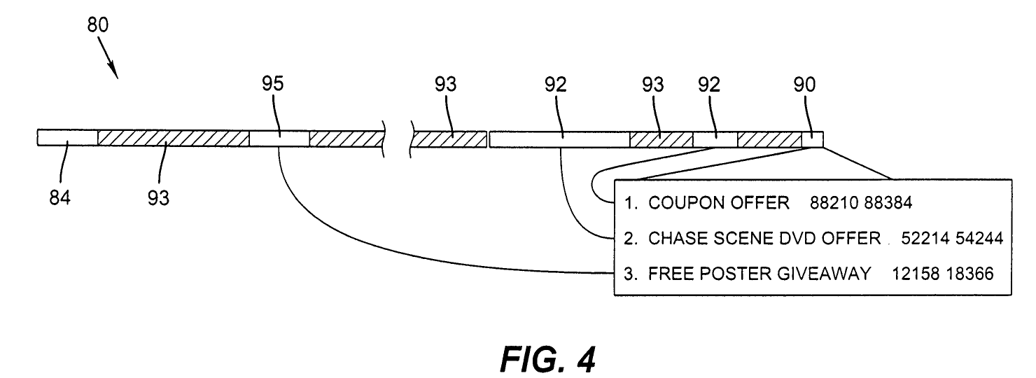

Referring to FIG. 4, there is shown an exemplary embodiment as a block diagram of transmitted data 80 sent by studio 110 (shown in FIG. 2) for a motion picture showing in one embodiment. Transmitted data 80 includes the motion picture data stream that contains the motion picture content from which one or more components can be copied and used to form a promotional product. Wireless transmission of promotional item image data via hand-held communication devices such as cellular phones, mobile phones, smart phones, personal digital assistants, pocket personal computers, and other like devices are contemplated as well.

An index 90, typically provided in the header of the motion picture data stream, gives a listing of various promotional portions 92 in the data stream of transmitted data 80 that follows and provides the needed information on type and location of each promotional portion 92. Some percentage of transmitted data 80 may consist of non-recordable portions 93 that cannot be decoded and are thus not available for reproduction at the theater. As the example of FIG. 4 shows, various scenes may be encoded as promotional portions 92, allowing reproduction of image content only, of audio content only, or of both audio and image content. Still image data 95 may also be provided within transmitted data 80.

Promotional portion 92 may be encoded for copy protection during transmittal; however, the intended receiving site has access to decoding information for promotional portion 92 content and is thus able to copy and use the data. Promotional portion 92 is, therefore, copiable. In contrast, non-recordable portion 93 is encoded to prevent its copying and re-use.

Additional data or header information can be provided in the digital data stream that classifies an image or scene or audio segment of the motion picture data stream as recordable or non-recordable. In this case, an exhibitor may be contractually bound to produce promotional items only from those segments of the motion picture data stream that are identified as recordable.

In the example of FIG. 4, promotional portions 92 provide some type of promotional content, whether this includes actual video or audio data that can be recorded onto media for the consumer, or includes promotional messages that are presented on-screen during the motion picture showing. For example, a message displayed on the screen during the showing may suggest purchase of a promotional item or prompt the viewer to respond to an offer in some way. Referring to FIG. 13, there is shown an auxiliary display screen 194 with a typical message, prompting audience members to order a copy of a scene. The message that displays should be appropriate to the particular exhibition site and to the fulfillment capabilities at that site. For example, if a theater has no poster printer but does have a DVD writer, prompts such as the message shown in FIG. 13 are made as appropriate for promotional items that can be generated using the DVD writer.

In an automated setting, a site profile can be set up as a separate operation from display of the film. In the site profile, a listing of available promotional items that a theater can produce can be maintained. That is, in one embodiment, site profile could be stored in a file, simply as a listing of items that are available from the site. Then, for messages provided as part of transmitted data 80, control logic processor 46 may allow only messages compatible with the site profile to be displayed, based on using the listing in the site profile. Similarly, only orders compatible with the site profile can be accepted.

Order Entry Alternatives

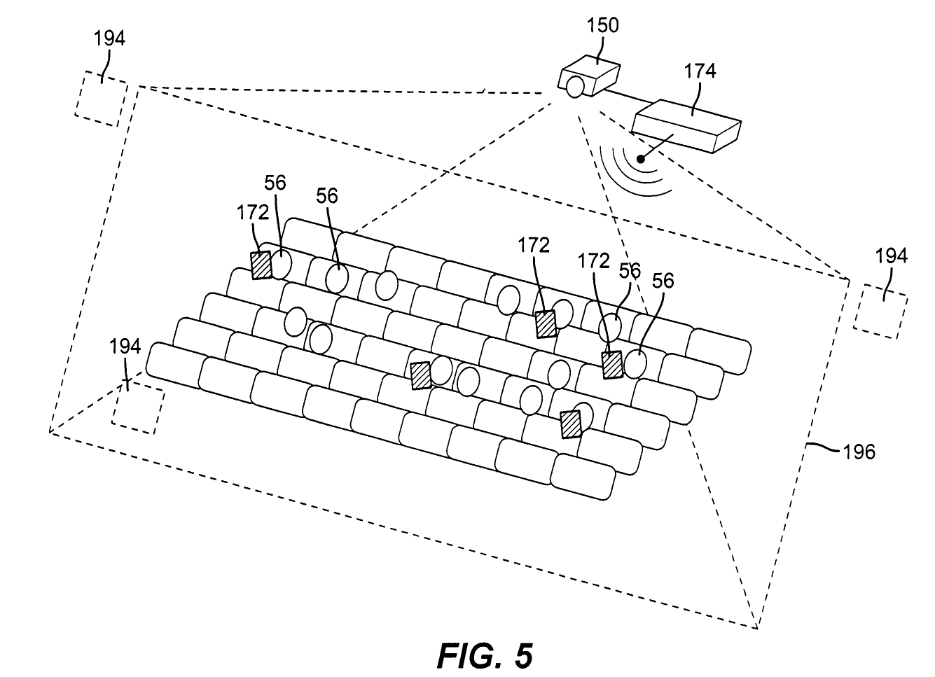

Referring to FIG. 5, there is shown, in block diagram form, in a perspective view from behind a projection screen 196 (shown in phantom to allow visibility of audience members and various order-related components) the basic mechanisms employed for obtaining viewer order entry response to promotional portion 92 in one embodiment using digital projection. Audience members, consumers 56, are provided with an order entry device 172 for recording an order for one or more promotional items during the movie or other entertainment event. Auxiliary display screen 194 may be positioned to either side of projection screen 196. Alternately, as also shown in phantom in FIG. 5, auxiliary display screen 194 may occupy a portion of the viewing area, either as a separate display or integrated into the main display on projection screen 196. A reader 174 is disposed in a suitable location for sensing consumer 56 entry of orders on order entry devices 172. In the embodiment of FIG. 5, for example, reader 174 is an RF transceiver that receives transmitted order data from order entry devices 172.

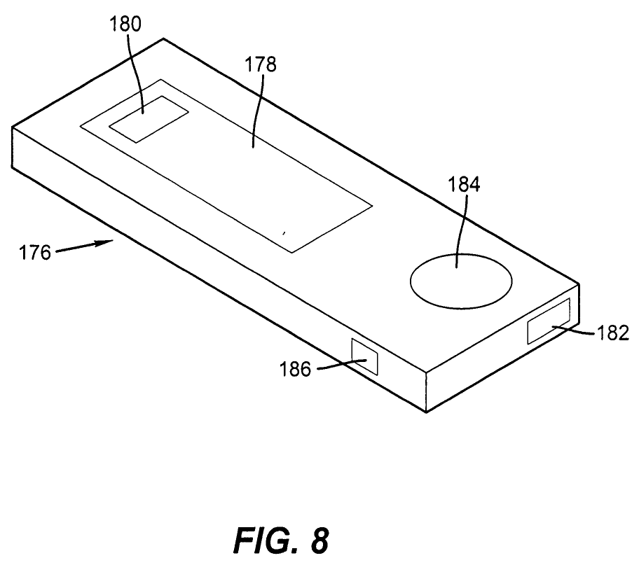

The embodiment of FIG. 5 is only one of many alternative embodiments in which an order entry device of some type obtains an order that has been recorded for a promotional item from an audience member during an entertainment event. Possible embodiments for order entry devices 172 include the use of an RF transponder, Bluetooth™ communication device, or other wireless apparatus, as is shown in FIG. 5 or an order entry console 176 that is provided to one or more audience participants, and shown in FIG. 8. Alternatively, the order entry device can be provided in some portion of the seating and may be wired to an ordering system, for example. In the embodiment of FIG. 8, order entry console 176 has a display 178 that provides one or more touch screen menu items 180. An optional audio input houses a microphone 182 for accepting audience orders or includes a speaker 184 for announcing the order. A security element 186 such as an RF tag is provided, to help prevent loss of order entry console 176 through theft or negligence.

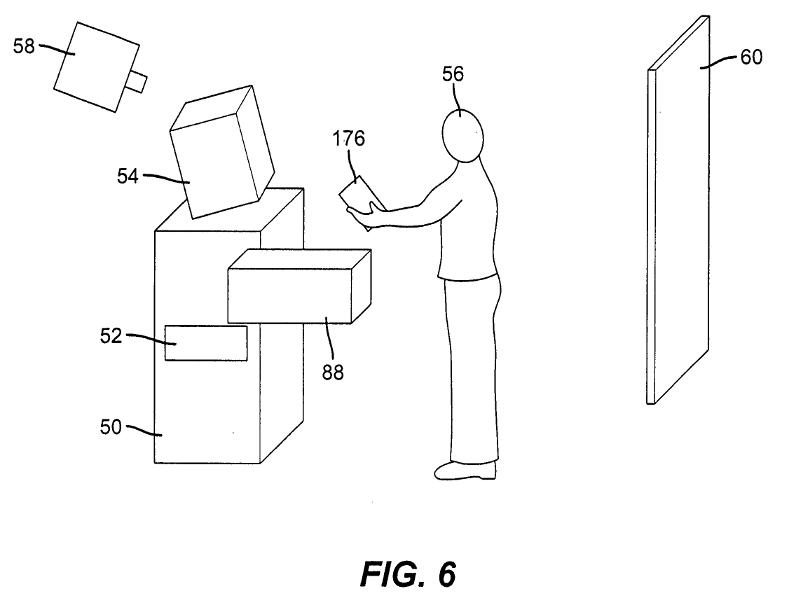

Referring to FIG. 6, one possible fulfillment arrangement is shown. Here, consumer 56 returns order entry console 176 to kiosk 50 for fulfillment. Order entry console 176 may be provided freely to one or more audience members, with or without a security deposit or refundable payment. Order entry console 176 may be disposable.

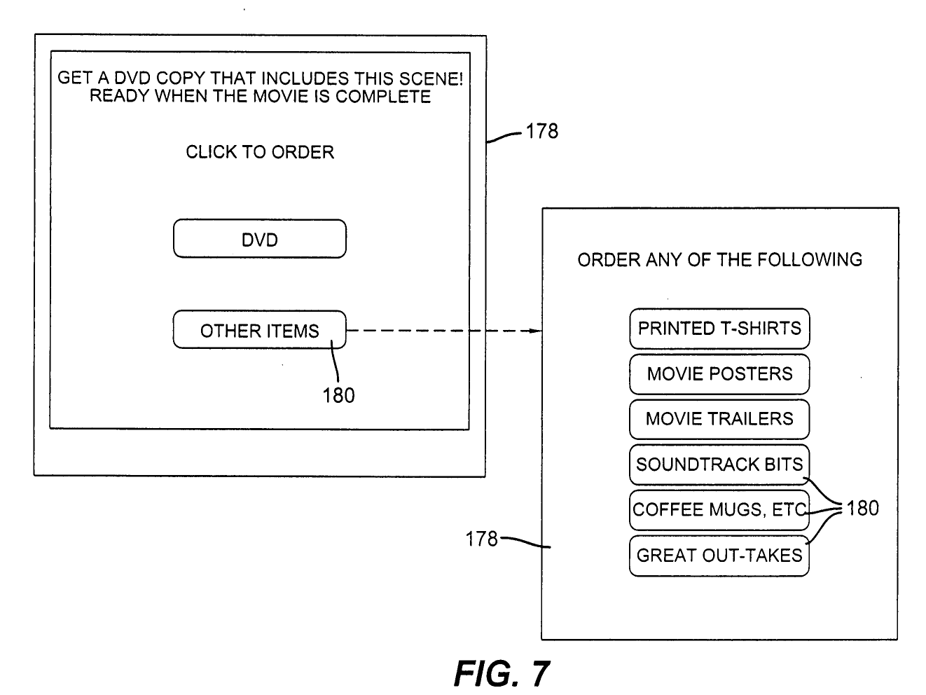

Referring to FIG. 7, there are shown sample display screens 180 that appear on display 178 of order entry console 176. Operator menu traversal and selection of menu items can be made using a touch screen or using a highlighting cursor that cycles through selections and provides a selection control, for example.

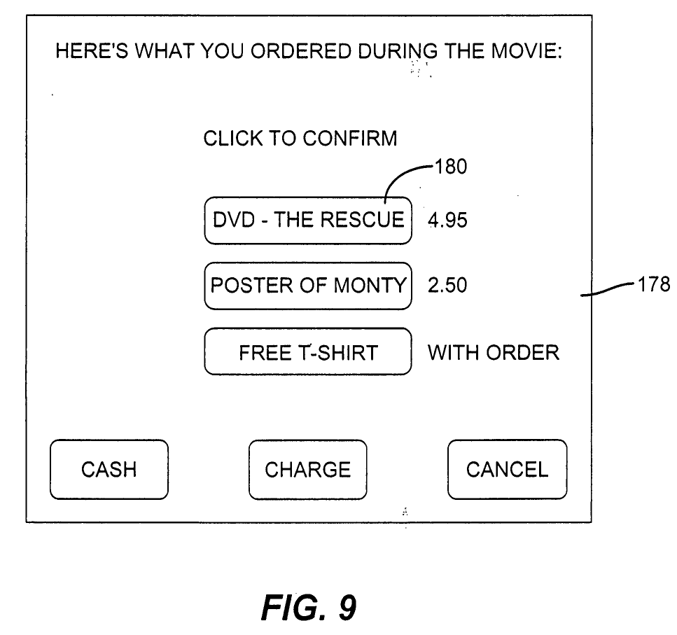

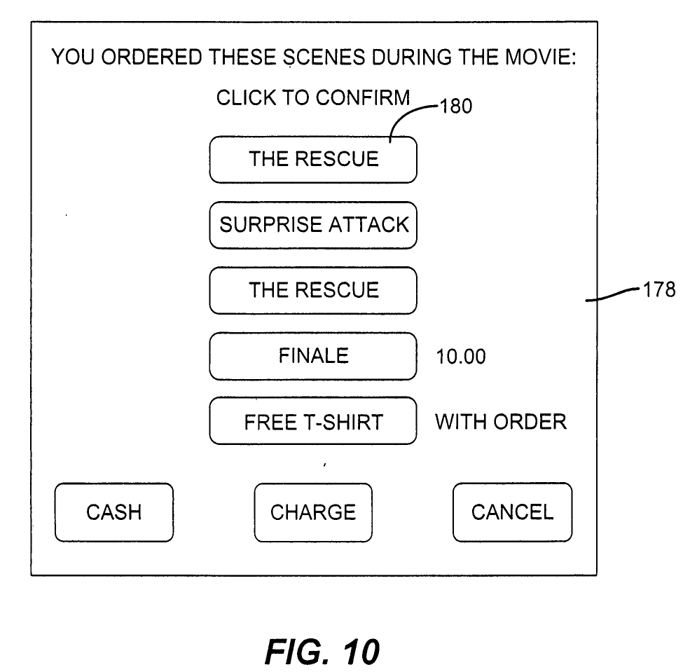

Referring to FIGS. 9 and 10, there are shown example displays 178 on order entry console 176 or on interface terminal 54 of kiosk 50 for summarizing orders placed and cost. Using kiosk 50, shown in FIG. 6, consumer 56 can receive items formed at recording apparatus 52 and pay for items using electronic transaction methods. Various methods for associating each order entry console 176 to an individual consumer 56 may be provided. Order entry console 176 may be provided to consumer 56 at the time of ticket purchase and encoded to place orders directly to a credit card account, for example.

In another embodiment, a cell phone, pager, PDA, or other personal electronic communication device carried by consumer 56 may be used as order entry device 172 for recording an order for promotional items. For example, a cell phone user may be instructed to dial in a certain key sequence, to place an order during the exhibition of a movie or other event. Alternatively, dialing in a certain code may enable the personal electronic communication device to receive prompts automatically for ordering promotional items. Where a theater may use jamming or other techniques to disable wireless communication devices such as cell phones or pagers during a showing, use of such blocking techniques would be suspended during periods in which order entry is allowed using wireless devices.

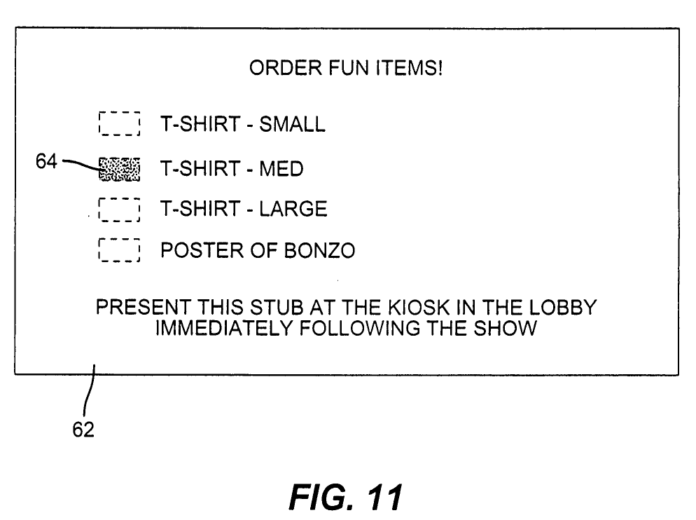

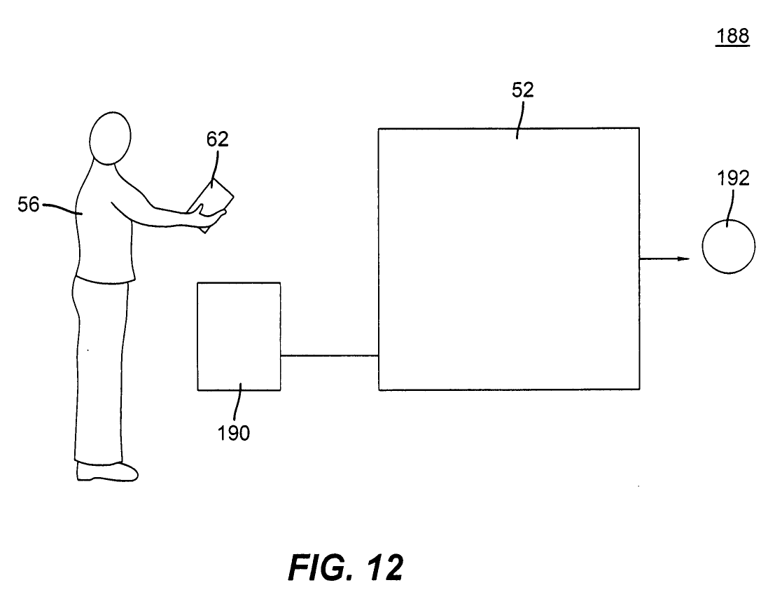

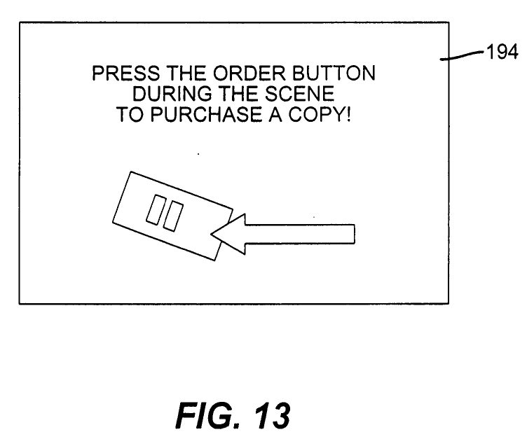

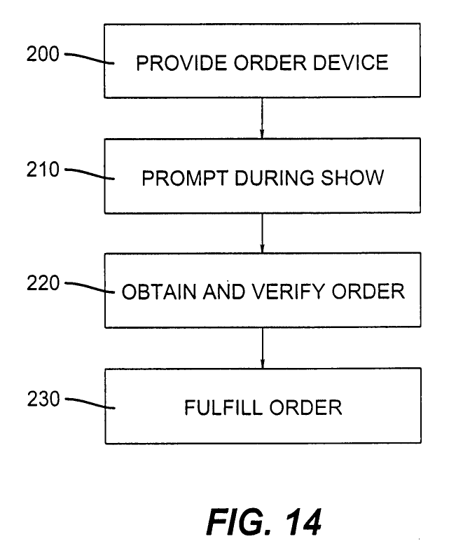

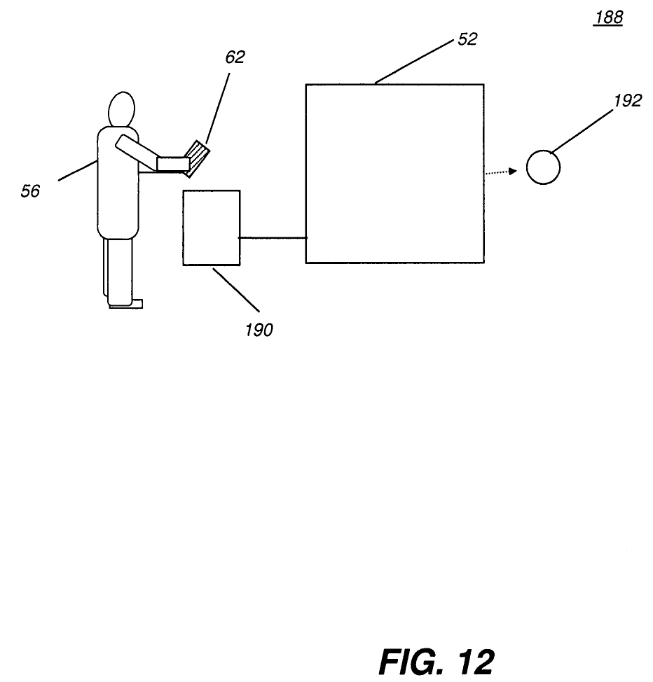

In yet another embodiment, as shown in FIG. 11, a ticket 62 provided, as an order recording device, to consumer 56 may be arranged to accept indicia 64 of some type to indicate an order entry. Indicia 64 may be a pencil marking or a removable portion such as a punch card, scratch-off element, or sticker, for manual operator entry of an order. Referring to FIG. 12, there is shown a fulfillment apparatus 188 for orders placed using ticket 62. A reader 190 reads indicia 64 on ticket 62 that indicate ordered scenes available on a DVD 192. Reader 190 output is provided to recording apparatus 52 that enables only selected scenes specified by the consumer. Payment can be made automatically to the same credit card used for purchasing ticket 62 or by a separate payment mechanism.

Referring again to FIG. 5, consumer 56 may be prompted to place an order in any of a number of ways. A message on display screen 194, which may be located in proximity to projection screen 196 as was described above, may prompt the consumer 56 to place an order during a particular point in the movie or other event. Such a prompt may appear on the main display screen or on an auxiliary display provided at the exhibition site. Alternatively, order entry console 176 may provide a visual, audible, or vibrational prompt to consumer 56. A PDA, cell phone, or other personal device may also provide a prompt. The cell phone maybe initiated when the consumer 56 enters the theater by dialing a specific number, such as *99 for example, that links to the theater's local ordering system.

Prompts provided may present a one-time opportunity to purchase an item; however, it is more likely that repeated prompts would elicit the intended response. At the conclusion of a motion picture showing, for example, a review listing of all available items may be presented for verification by consumer 56. A summary listing of all items ordered may also be presented, as was shown in FIG. 10. A quick summary of key scenes may be presented at the conclusion of a motion picture, for example, allowing customers 56 to verify, correct, and complete their orders, such as during the film credits, for example.

Cell phone users may be presented with any of a number of possible order entry options using these personal communications devices. For example, a timed period may be used for accepting orders for each item. Or, orders may be available by entering separate key pad sequences, for example.

Fulfillment Options

There are a number of possible options for providing the promotional item that is ordered during the entertainment event. The promotional item may be reserved for consumer 56 and available for pick-up and payment following the movie showing, for example. Or, it may be advantageous to provide a web site for reviewing the ordered items; however, this loses the advantage of impulse buying and providing the item at the theater or exhibition site itself.

Where scenes have been ordered, these can be provided on DVD or other storage medium, as described above, such as a removable memory circuit, for example. Alternatively, ordered video and/or audio can be provided as streamed data, written directly to a PDA or other personal device or computer having sufficient memory storage capacity. For example, a video or audio snippet could be provided for use on a cell phone or PDA display itself, as a programmed ring tone. If the video or audio snippet is to be provided to the personal device, the data transfer can take place immediately after consumer 56 has indicated a desire to order the video or audio snippet. The fulfillment can occur via a wireless device of the consumer 56 during the showing or sometime thereafter.

It must be observed that the promotional item may or may not be obtained using data provided with the motion picture data stream or with other data. The method and apparatus of the present invention offer special advantages when used in conjunction with digital cinema applications; however, use of this method and apparatus with conventional film-based projection equipment is also possible. Where the promotional item is derived from the image data stream, there may be some adaptation of the data for forming the promotional item. For example, if scenes from a motion picture are provided, there may be some conditioning of the original data in order to make it more suitable for storage formats or for lower-resolution display equipment.

Recorded data provided to consumer 56 using this ordering mechanism can include any of the following, singly or in combination, for example:
(i) One or more scenes from the motion picture. This might include a complete scene or some portion of a key scene in the motion picture, suitably conditioned for reproduction onto DVD, tape, or other recording medium. This conditioning may include, for example, reducing the resolution from that required for a motion picture display screen to the resolution needed for television viewing, as was noted hereinabove. As another option, the recorded data could be the complete movie. Different versions of the movie could be available, with content varied for different age ratings or including and excluding different scenes, providing a long or short version, for example. Audio content or subtitles in many languages could be included. One or more key scenes, such as a chase scene having a specific sound track could be provided.
(ii) One or more images from motion picture content. This could include a “screen capture” still image that can be printed onto a reflective medium such as paper or onto a transparent medium. Images could also be printed onto T-shirts or other articles.
(iii) One or more audio sequences from the motion picture. This could include key dialog, catch phrases, the movie theme, or songs and other musical sequences extracted from the movie data stream.

A feedback mechanism (not shown) could optionally be provided to report back to studio 110 when a promotional product is provided at the exhibition site. This type of feedback information could be used for tracking and billing purposes, for example.

In addition to promotional portions 92, as shown in FIG. 4, transmitted data 80 may also include one or more supplemental data components 84 for providing other promotional items along with the transmitted data, including posters, banners, video out-takes, and other items, as disclosed in commonly assigned copending applications: “Promotional Materials Within Digital Cinema Data Stream” Ser. No. 10/924,613 in the names of David L. Patton and John R. Fredlund; and, “Promotional Materials Derived from Digital Cinema Data Stream”, Ser. No. 10/960,828 in the names of David L. Patton and John R. Fredlund, which are both incorporated herein by reference. Supplemental data components in the image data stream may include instructions for rendering any promotional items from images in the motion picture data stream or instructions for creating composite images using elements of a plurality of images or portions of images or audio segments from the motion picture data stream. Some items may be immediately available before or following a showing; others may be shipped to consumer 56 or available for pick-up at a later time. Various types of billing arrangements could be used, including billing directly to a credit card or billing through a cell phone service provider, for example.

Kiosk 50 for Selection and Customization

Referring to FIG. 6, there is shown an arrangement of kiosk 50 in one embodiment. Kiosk 50 can be placed in the lobby at the theater site, and can be operated by a consumer 56 or by theater personnel. Kiosk 50 typically includes an interface terminal 54 that enables consumer 56 to order any of various promotional items that have been provided within the motion picture data. For example, interface terminal 54 may provide a touch screen menu of selections, as shown in the example screen sequence of FIG. 7. A main menu screen 70 lists options for ordering. The full set of available promotional items can be extensive and may include such items as posters, coffee mugs, iron-on cloth patches and T-shirts of various designs, CDs having movie soundtrack or one or more celebrity interviews, songs, or theme segments, or DVDs with one or more scenes from the movie content, for example. Consumer 56 makes a selection by pressing a touch screen button 72 and successively works through additional menu screens 74 to specify the promotional item ordered. Alternatively, consumer 56 may insert a ticket into a scanner 88 at kiosk 50, and the menu appropriate to the show for which the ticket corresponds may be selected. Of course, there are many options for user interface design that would allow customers themselves to specify promotional item type and characteristics and also selections of specific content such as song titles or movie clips as would be familiar to one skilled in the user interface arts. In addition, kiosk 50 may provide non-copiable samples of various promotional items, allowing playback of various video or audio content, allowing a customer to order an item for later shipment. Wireless communication with the kiosk 50 is possible using known means such as Bluetooth™ and/or other equivalent wireless transmission means.

In other embodiments, kiosk 50 may serve as more than an order station. A camera 58 and display 60 may also be provided as part of the configuration of kiosk 50, allowing consumer 56 to obtain a custom image on a promotional item. For example, camera 58 may obtain an image of the face of consumer 56 for combination with a prepared background that may appear on display 60 or may be stored internally. This would enable consumer 56 to be placed within a scene or costume appropriate to the motion picture. A copy of one or more scenes of a motion picture could be provided to a consumer, custom-tailored so that the consumer is pictured as a participant within the scene in the copy provided.

Transaction Details

In one embodiment, theater 28 (shown in FIG. 1) pays a license fee for providing promotional items. Tracking software is also provided in order to maintain some measure of control in this printing arrangement. In one embodiment, tracking software permits the copying or printing of a limited number of promotional items; attempts to exceed these limits may lead to the requirement to purchase a more expensive license, for example. Tracking software can also be used to report the number of promotional items fabricated in order for studio 110 to obtain some percentage of the profits.

Consumer payment can also be obtained in a number of different ways. In one embodiment, consumer 56 pays directly at the kiosk 50 with an electronic transaction, swiping a credit card through a reader after making an order, for example. A deposit may be placed on order entry console 176 (shown in FIG. 8) and credited toward a purchase. Order entry console 176 itself may accept payment directly from consumer entry. A cell phone or other personal electronic device may also be used to obtain payment information and/or authorization from the consumer.

It can be appreciated that entertainment system 40 (shown in FIG. 3) of the present invention provides the theater owner with a number of unique advantages for profit and can help to enhance the entertainment experience of consumer 56. The theater owner is not burdened with the task of storing and maintaining inventory of items that can only be profitably sold while a motion picture is shown at the site. For example, instead of ordering hundreds of DVD copies for each movie being shown, the theater owner can stock a reasonable number of DVDs and provide copies of the movie on them, complete with printed labels, as ordered. Moreover, as noted above, the theater can provide copies of different versions, such as by length, by age rating (P, PG, R, etc.), or by other criteria. The consumer, meanwhile, has an opportunity to purchase a promotional item at the theater itself, before, during, or after the showing.

By allowing the theater to obtain orders placed by a consumer 56 during an entertainment event, the method of the present invention creates additional profit opportunities for both the theater and the film distributor. Moreover, the method of the present invention allows promotional items ordered during an entertainment event to be ordered and fabricated during the event, so that the items can be obtained and paid for at the conclusion of the event.

Workflow Example

By way of example, the flow diagram of FIG. 14 shows the basic steps for using the present invention. In a provide order device step 200, the operator of the theater or other event organizer provides consumers 56 with one or more options for ordering promotional items during the showing. For example, consumer 56 may have a cell phone that can be used to order items, following instructions provided by the theater. Other consumers 56 may be provided with an ordering device such as order entry console 176 shown in FIG. 8. Still other consumers 56 may use a manual order entry device, such as the reverse side of their ticket.

During the showing, in a prompt step 210, the theater prompts consumers 56 to record an order for various promotional items. This prompting can occur in a number of different ways. Cellphone users may receive an audio signal, for example. Other consumers 56 may see a message on auxiliary display screen 194 (FIG. 5). In an order entry and verification step 220, the recorded order itself is entered in any of a number of ways, depending on the order entry method used. Cellphone users may receive a message in home email, for example. Consumers using a manual device or ticket may enter orders and receive order confirmation at kiosk 50 in the lobby. The order entry device used is scanned in some manner at kiosk 50, such as by an RF reader, scanner 88, or other reader mechanism. Consumer 56 then receives the promotional item in a fulfillment step 230.

The basic sequence shown in FIG. 14 admits considerable variety in implementation. For example, prompt step 210 may occur just before or after the showing and may be issued only once or repeated as often as is desirable. Audience members may even be able to request a repeat of one or more prompt messages when using an electronic order entry device, for example. Order entry and verification step 220 may take place during the showing, such as when an electronic order entry device mechanism is employed, or may take place afterwards. Some verification from consumer 56 may be necessary, depending on the item ordered and payment option selection. In the same audience, multiple types of order entry devices could be used.

Fulfillment step 230 may also take any of a number of forms, depending on the nature of the promotional item that is ordered. With electronic media, where the ordered item is in a file format, such as a scene portion, audio track, or image, the order can be entered, verified, and fulfilled by downloading the file format data during the showing. This may be downloaded directly to a personal electronic device owned by consumer 56 or may be downloaded to a remote computer address, such as a home computer for example.

The method and apparatus of the present invention allow audience members to order promotional items related to a motion picture or to an electronically broadcast performance event while in the movie theater or other exhibition site. The present invention permits a significant amount of flexibility to theater owners and exhibition site personnel, allowing orders for promotional items to be obtained during an immediately following an entertainment event. The present invention allows many types of items to be fabricated during the showing, so that they are ready for consumer 56 at the end of the entertainment event.

The invention has been described in detail with particular reference to certain preferred embodiments thereof, but it will be understood that variations modifications can be effected within the scope of the invention as described above, and as noted in the appended claims, by a person of ordinary skill in the art without departing from the scope of the invention.

### Parts List

10 Motion picture film distribution system
20 Studio
22 Content providers
24 Print film
26 Distribution network
28 Theater
30 Content films
40 Entertainment system
44 Network
46 Control logic processor
48 Large-format printer
50 Kiosk
52 Recording apparatus
54 Interface terminal
56 Consumer
58 Camera
60 Display
62 Ticket
64 Indicia
70, 74, 76 Menu screen
72 Touch screen button
80 Transmitted data
82 Motion picture component
84 Supplemental data component
88 Scanner
90 Index
92 Promotional portion
93 Non-recordable portion
95 Image data
98 Reader
100 Digital cinema preparation and distribution system
110 Studio
112 Film
114 Datacine system
116 Auxiliary input devices
118 Rendering system
120 Disk array
122 Transmitter
130 Transmission system
132 Magnetic medium
134 Optical medium
136 Fiber cable connection
138 Satellite
140 Exhibition system
142 Magnetic media reader
144 Optical media reader
146 Cinema operating system
148 Receiver
150 Digital projector
160 Memory buffer
162 Conditioning circuit
164 Recording medium
172 Order entry device
174 Reader
176 Order entry console
178 Display
180 Menu item
182 Microphone
184 Speaker
186 Security element
188 Fulfillment apparatus
190 Reader
192 DVD
194 Auxiliary display screen
196 Projection screen
200 Provide order device step
210 Prompt step
220 Order entry and verification step
230 Fulfillment step

What is claimed is:

1. A method for providing, at an exhibition site, a promotional item, the method comprising the steps of:
(a) displaying a motion picture at the exhibition site;
(b) providing, to at least one audience member, an order entry device for recording an order for the promotional item during the motion picture showing; and,
(c) obtaining the order placed using the order entry device.

2. A method according to claim 1 further comprising the step of prompting the at least one audience member during the showing to place an order using the order entry device.

3. A method according to claim 2 wherein the promotional item comprises some portion of motion picture content and wherein the step of prompting the at least one audience member occurs during a time interval immediately following display of a corresponding portion of the motion picture available for ordering.

4. A method according to claim 2 wherein the step of recording the order for the promotional item during the motion picture showing occurs during a predetermined interval following a prompt.

5. A method according to claim 2 further comprising the step of determining which items are available at the exhibition site according to predetermined site profile data.

6. A method according to claim 1 wherein the promotional item is selected from the group consisting of a poster, a DVD, an audio recording, a video with audio segment of the movie, an item of apparel, a tattoo, a coupon, an eating utensil, a banner, and game software.

7. A method according to claim 2 wherein the step of prompting is repeated at the conclusion of the motion picture showing.

8. A method according to claim 2 wherein the step of prompting comprises the step of decoding prompt instructions encoded in a digital data stream for the motion picture.

9. A method according to claim 1 wherein the step of obtaining the order comprises the step of reading a memory on the order entry device.

10. A method according to claim 2 wherein the step of prompting comprises the step of providing an audio signal.

11. A method according to claim 2 wherein the step of prompting comprises the step of providing a visual signal.

12. A method according to claim 2 wherein the step of prompting comprises the step of providing a vibrational signal.

13. A method according to claim 1 wherein the step of recording the order is performed during the motion picture showing.

14. A method according to claim 13 further comprising the step of fabricating the promotional item during the motion picture showing.

15. A method according to claim 1 wherein the step of obtaining the order comprises the step of receiving a wireless transmission.

16. A method according to claim 1 wherein the step of obtaining the order is performed at an order receiving apparatus located at the exhibition site.

17. A method according to claim 1 wherein the step of recording the order comprises the step of transmitting the order to a networked site.

18. A method according to claim 2 wherein the step of prompting comprises the step of providing a visual message on a display screen.

19. A method according to claim 1 wherein the step of obtaining the order comprises the step of verifying audience member response recorded during the motion picture showing.

20. A method according to claim 1 further comprising the step of fulfilling the order by providing data for displaying scenes derived from the motion picture.

21. A method according to claim 20 wherein the data is recorded onto a storage medium taken from the group consisting of a DVD, a random-access memory device, and a magnetic tape.

22. A method according to claim 1 further comprising the step of fulfilling the order for the promotional item by downloading data.

23. A method according to claim 1 wherein the step of obtaining an order comprises the step of scanning a ticket stub.

24. A method according to claim 1 wherein the step of providing an order entry device comprises the step of enabling a hand-held communication device carried by the audience member.

25. A method according to claim 24 wherein the step of enabling a hand-held communication device carried by the audience member comprises entering a predetermined code.

26. A method according to claim 1 further comprising the step of providing order data to a networked site.

27. A method according to claim 1 wherein the order entry device is disposable.

28. A method according to claim 1 wherein the order entry device comprises a display.

29. A method according to claim 1 wherein the order entry device comprises an audio speaker.

30. A method according to claim 1 wherein the order entry device comprises a security tag.

31. A method according to claim 1 wherein the promotional item is obtained from a digital motion picture data stream.

32. A method according to claim 1 wherein the order entry device comprises a touch screen.

33. A method for providing a promotional item at an entertainment event, the method comprising the steps of:
(a) providing, to at least one audience member, a wireless order entry device for ordering the promotional item during the event;
(b) displaying a prompt to the at least one audience member for recording an order for the promotional item using the order entry device during the event;
(c) obtaining, from wireless transmission, the order recorded using the order entry device.

34. A method for providing a promotional item at an entertainment event, the method comprising the steps of:
(a) providing, to at least one audience member, an entry device for ordering the promotional item during the event;
(b) displaying a prompt to the at least one audience member for recording an order for the promotional item using the order entry device during the event;
(c) obtaining, from wired transmission, the order placed using the order entry device.

35. A method according to claim 33 further comprising the step of fulfilling the order by transmitting data to the wireless device.

36. A method according to claim 35 wherein the step of fulfilling the order comprises providing a ringtone or video snippet to be used as a ringtone.

37. A method for providing a promotional item at an entertainment event, the method comprising the steps of:
(a) providing, to at least one audience member, a manual entry device for recording an order for the promotional item during the event;
(b) displaying a prompt to the at least one audience member for ordering the promotional item using the order entry device during the event; and,
(c) obtaining a completed manual entry device from the at least one audience member.

38. A method according to claim 37 wherein the step of displaying a prompt comprises recording the prompt on the manual entry device.

39. A method according to claim 37 wherein the order entry device comprises a ticket.

40. A method according to claim 37 wherein the step of obtaining a completed manual entry device further comprises the step of scanning the device to obtain the order.

41. A method according to claim 39 wherein the step of recording an order comprises the step of removing an area of the ticket.

42. A method for providing a promotional item at an entertainment event, the method comprising the steps of:
(a) providing, to at least one audience member, a ticket to the entertainment event;
(b) scanning the ticket; and,
(c) displaying a selection menu for selection of promotional items corresponding to the entertainment event.

43. A method according to claim 1 wherein the step of obtaining the order comprises the step of disabling a message jamming signal at the exhibition site.

44. A method according to claim 24 wherein the step of obtaining the order comprises the step of receiving any one of a set of possible key sequences from the hand-held communication device.

45. A method according to claim 24 further comprising the step of billing a user account associated with the hand-held communication device.
